(19) United States
(12) Patent Application Publication
(10) Pub. No.: US 2020/0074944 A1
(43) Pub. Date: Mar. 5, 2020

(54) METHOD AND APPARATUS FOR DRIVING DISPLAY APPARATUS

(71) Applicants: HKC Corporation Limited, Shuitian Village ,Shiyan Sub-district (CN); Chongqing HKC Optoelectronics Technology Co., Ltd., Chongqing (CN)

(72) Inventor: Chih-Tsung KANG, Chongqing (CN)

(21) Appl. No.: 16/064,397

(22) PCT Filed: Jan. 22, 2018
(86) PCT No.: PCT/CN2018/073596

§ 371 Date: Jun. 20, 2018

(30) Foreign Application Priority Data
Dec. 21, 2017 (CN) 201711396537.4

(51) Int. Cl. G09G 3/36

(52) U.S. Cl. CPC G09G 3/3607

(57) ABSTRACT

A method for driving a display apparatus: average signals of sub pixel units in a zone are calculated to obtain a zone first average signal, a zone second average signal, and a zone third average signal; a smallest average signal as a lowest average signal sub pixel in terms of a dominant hue out of first, second, and third hues is determined according to the average signals in the zone; that minimum signals of most pixel units in the zone are hues of one sub pixel of the first, the second, and the third is determined; frame signal combination and allocation are performed; a calculation of a minimum average signal in a frame sub pixel signal is determined according to a zone average value range, zone frame times are determined, and luminance of first, second, and third light sources is correspondingly adjusted; and a backlight luminance is adjusted.

### BACKGROUND

### Technical Field

### This application relates to a method for designing a display panel, and in particular, to a method and an apparatus for driving a display apparatus.

### Related Art

A liquid-crystal display (LCD) is a flat thin display apparatus, is formed by a quantity of color or black and white pixels, and is disposed in front of a light source or a reflecting surface. Each pixel comprises the following parts: a liquid crystal molecular layer suspending between two transparent electrodes, and two polarization filters, with polarization directions perpendicular to each other, disposed on two outer sides. If there is no liquid crystal between electrodes, when light passes through one of the polarization filters, a polarization direction of the light is completely perpendicular to the second polarization filter, and therefore the light is completely blocked. However, if the polarization direction of the light passing through one of the polarization filters is rotated by liquid crystals, the light can pass through the other polarization filter. Rotation of the polarization direction of the light by the liquid crystals may be controlled by means of an electrostatic field, so as to implement control on the light.

Before charges are applied to transparent electrodes, arrangement of liquid crystal molecules is determined by arrangement on surfaces of the electrodes. Surfaces of chemical substances of the electrodes may be used as seed crystals of crystals. In most common twisted nematic (TN) liquid crystals, two electrodes above and below liquid crystals are vertically arranged. Liquid crystal molecules are arranged in a spiral manner. A polarization direction of light passing through one of the polarization filters rotates after the light passes through a liquid crystal sheet, so that the light can pass through the other polarization filter. In this process, a small part of light is blocked by the polarization filter, and looks gray when being seen from outside. After the charges are applied to the transparent electrodes, the liquid crystal molecules are arranged in a manner of being almost completely arranged in parallel along an electric field direction. Therefore, a polarization direction of light passing through one of the polarization filters does not rotate, and therefore the light is completely blocked. In this case, a pixel looks black. A twisting degree of arrangement of the liquid crystal molecules can be controlled by means of voltage control, so as to achieve different grayscales.

Because liquid crystals do not have colors themselves, a color filter is used to generate various colors, and is a key component for turning grayscales into colors of an LCD. A backlight module in the LCD provides a light source, and then grayscale display is formed by means of a drive IC and liquid crystal control, and the light source passes through a color resist layer of the color filter to form a color display image.

### SUMMARY

To resolve the foregoing technical problems, an objective of this application is to provide a method for designing a display panel, and in particular, to a method for driving a display apparatus. The method comprises: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that minimum signals of most pixel units in the zone are hues of one sub pixel of the first; the second, and the third; performing frame signal combination and allocation; obtaining, according to a zone average value range, a calculation of a minimum average signal in a frame sub pixel signal, determining zone frame times, and correspondingly adjusting luminance of first, second, and third light sources; and adjusting a backlight luminance.

To achieve the objective of this application and resolve technical problems of this application, the following technical solutions are used. A method for driving a display apparatus according to this application is provided and comprises: calculating average signals of sub pixel units in a zone to obtain a zone first average signal, a zone second average signal, and a zone third average signal; determining, according to the average signals in the zone, a smallest average signal as a lowest average signal sub pixel in terms of a dominant hue out of first, second, and third hues; determining that minimum signals of most pixel units in the zone are hues of one sub pixel of the first, the second, and the third; performing frame signal combination and allocation; obtaining, according to a zone average value range, a calculation of a minimum average signal in a frame sub pixel signal, determining zone frame times, and correspondingly adjusting luminance of first, second, and third light sources; and adjusting a backlight luminance.

To further achieve the objective of this application and resolve technical problems of this application, the following technical measures may be taken.

Another objective of this application is to provide an apparatus for driving a display apparatus. The apparatus comprises at least one zone, where each zone comprises a plurality of pixel units, and each pixel unit comprises a first sub pixel unit, a second sub pixel unit, and a third sub pixel unit; and the apparatus is configured to: calculate average signals of sub pixel units in a zone to obtain a zone first average signal, a zone second average signal, and a zone third average signal; determine, according to the average signals in the zone, a smallest average signal as a lowest average signal sub pixel in terms of a dominant hue out of first, second, and third hues; determine that minimum signals of most pixel units in the zone are hues of one sub pixel of the first, the second, and the third; perform frame signal combination and allocation; obtain, according to a zone average value range, a calculation of a minimum average signal in a frame sub pixel signal, determine zone frame times, and correspondingly adjust luminance of first, second, and third light sources; and adjust a backlight luminance.

Another objective of this application is to provide an apparatus for driving a display apparatus. The apparatus comprises at least one zone, where each zone comprises a plurality of pixel units, and each pixel unit comprises a first sub pixel unit, a second sub pixel unit, and a third sub pixel unit; and the apparatus is configured to: calculate average signals of sub pixel units in a zone to obtain a zone first average signal, a zone second average signal, and a zone third average signal; determine, according to the average signals in the zone, a smallest average signal as a lowest average signal sub pixel in terms of a dominant hue out of first, second, and third hues; determine that minimum signals of most pixel units in the zone are hues of one sub pixel of the first, the second, and the third; perform frame signal combination and allocation; obtain, according to a zone average value range, a calculation of a minimum average signal in a frame sub pixel signal, determine zone frame times, and correspondingly adjust luminance of first, second, and third light sources; and adjust a backlight luminance, where the zone average value range is a first condition range, and the calculation of the minimum average signal in the frame sub pixel signal is a second condition range, so that the zone frame times is determined and the luminance of first, second, and third light sources is correspondingly adjusted.

In an embodiment of this application, a first hue combination when average signals of sub pixel units in the zone is the first average signal, the second average signal, and the third average signal, where the first average signal>the second average signal>the third average signal; if in the zone, there is a first hue combination whose pixel units are a first pixel unit, a second pixel unit, and a third pixel unit; and if an order of grayscale signals when the first pixel unit>the second pixel unit>the third pixel unit is the same as an order of grayscale signals when the average signals in the zone is the first average signal, the second average signal, and the third average signal, where the first average signal>the second average signal>the third average signal, that a minimum common signal of the first pixel unit, the second pixel unit, and the third pixel unit of the sub pixel unit is the third pixel unit is obtained.

In an embodiment of this application, the grayscale signals of the first pixel unit, the second pixel unit, and the third pixel unit of the sub pixel unit are changed from one frame to signal combinations of three frames; a frame 1 is a combination of a first first pixel unit, a first second pixel unit, and a first third pixel unit; a frame 2 is a combination of a second first pixel unit, a second second pixel unit, and a second third pixel unit; and a frame 3 is a combination of a third first pixel unit, a third second pixel unit, and a third third pixel unit, where the signal combinations of the frame 1, the frame 2, and the frame 3 satisfy: the first first pixel unit+the second first pixel unit+the third first pixel unit=the first pixel unit, the first second pixel unit+the second second pixel unit+the third second pixel unit=the second pixel unit, and the first third pixel unit+the second third pixel unit+the third third pixel unit=the third pixel unit.

In an embodiment of this application, in the combination 1 of the first first pixel unit, the first second pixel unit, and the first third pixel unit of a sub pixel signal of the frame 1, a minimum color third pixel unit and a pixel signal third pixel unit of the sub pixel unit are used as a common sub pixel signal of the frame, that is, the first first pixel unit=the third pixel unit, the first second pixel unit=the third pixel unit, and the first third pixel unit=the third pixel unit.

In an embodiment of this application, the second first pixel unit, the second second pixel unit, and the second third pixel unit of a sub pixel signal of the frame 2 is one sub pixel color of a common sub pixel signal of differences between the first pixel unit, the second pixel unit, and the third pixel unit of an original signal and those of the signal of the frame 1, that is, first, second, and third sub pixel difference signals are respectively the first pixel unit-the third pixel unit, the second pixel unit-the third pixel unit, and 0, where when a first sub pixel signal of the difference signal is used in the frame 2, a sub pixel signal combination of the frame 2 is: the second first pixel unit=the first pixel unit-the third pixel unit, the second second pixel unit=0, and the second third pixel unit=0.

In an embodiment of this application, the frame 3 is another second sub pixel signal of the difference signal, and a sub pixel signal combination of the frame 3 is: the third first pixel unit=0, the third second pixel unit=the second pixel unit—the third pixel unit, and the third third pixel unit=0.

In an embodiment of this application, the zone average value range is a first condition range, and the calculation of the minimum average signal in the frame sub pixel signal is a second condition range, so that the zone frame times is determined, and the luminance of the first, second, and third light sources is correspondingly adjusted.

In an embodiment of this application, the first condition range and the second condition range are selected from the following determining cases: a first case: when a first condition range is the first average signal>the second average signal>the third average signal, the third average signal is the minimum average color signal, regarding compensation signals in a frame 2 in the zone, whether compensation signals exists in continuous sub pixels is determined, a signal that needs to be theoretically compensated for the color in the frame 2 in the zone is calculated, and statistics on all compensation signals in the zone are collected; and when a second condition range satisfies a condition that if in a sub pixel signal in the frame 2 in the zone, continuous sub pixels of a matrix array value satisfies a condition: the sub pixel signal in the frame 2≥a percentage of a first high saturation exceeding a percentage of a value, where the matrix array is a customizable feature zone block sub pixel matrix range, the first high saturation is customizable and indicates that satisfied compensation signals exceeds a threshold, the value is a customizable ratio of a quantity of sub pixels, in continuous sub pixels of the matrix array value, exceeding the first high saturation compensation signals, a third light source signal in the frame 2 is not adjusted to 0 and strengths of third light sources that are backlight sources both in a frame 1 and the frame 2 are still kept to 3 times of an original backlight, where when the average signals in the zone are in other order combinations, for example, if the first average signal>the third average signal>the second average signal, the third average signal>the second average signal>the first average signal, the third average signal>the first average signal>the second average signal, the second average signal>the first average signal>the third average signal, the second average signal>the third average signal>the first average signal, regarding minimum average sub pixel colors in the zone: first, second, and third, whether luminance of first, second, and third signals of the backlight source in the frame 2 is adjusted to 0;

a second case: when a first condition range is the first average signal=the first average signal>the second average signal=the second average signal>the third average signal=the third average signal, the third average signal is the minimum average color signal, regarding compensation signals in a frame 2 in the zone, whether compensation signals exists in continuous sub pixels is determined, a signal that needs to be theoretically compensated for the color in the frame 2 in the zone is calculated, and statistics on all compensation signals in the zone are collected; and when a second condition range satisfies a condition that if sub pixel signals in the frame 2 in the zone satisfies a condition: the sub pixel signals in the frame 2≥a percentage, exceeding a percentage of another value, of sub pixels of a second high saturation to a quantity of all the sub pixels in the frame 2 in the zone, where the second high saturation is customizable and indicates that satisfied compensation signals exceeds a threshold, the another value is a customizable ratio of a quantity of sub pixels, in all the sub pixel signals in the frame 2 in the zone, exceeding the second high saturation compensation signals, a third light source signal in the frame 2 is not adjusted to 0 and strengths of third light sources that are backlight sources both in a frame 1 and the frame 2 are still kept to 3 times of an original backlight, wherein when the average signals in the zone are in other order combinations, for example, if the first average signal>the third average signal>the second average signal, the third average signal>the second average signal>the first average signal, the third average signal>the first average signal>the second average signal, the second average signal>the first average signal>the third average signal, the second average signal>the third average signal>the first average signal, regarding minimum average sub pixel colors in the zone: first, second, and third, whether luminance of first, second, and third signals of the backlight source in the frame 2 is adjusted to 0; and

a third case: when a first condition range is a first hue combination when the first average signal=the first average signal, the second average signal=the second average signal, and the third average signal=the third average signal, most sub pixel combinations are grayscale signals the first average signal>the second average signal>the third average signal; and when a second condition range does not satisfy calculation and determining formulas in the first case and the second case, a third light source signal in a frame 2 is adjusted to 0, a second light source signal in the frame 2 is adjusted to 0, and first and third light source signals in a frame 3 are adjusted to 0.

In this application, by means determining on signals of a first, second, and third sub pixel combination, each group of first, second, and third sub pixel input signals are divided into three frame signals for display, and a driving frequency of a display needs to be tripled to separately display the three divided frame signals. By means of the three divided frame signals, main tone luminance in a side viewing angle is improved, a ratio of the main tone luminance of a main sub pixel in the side viewing angle to a luminance of an original frame low-voltage sub pixel in the side viewing angle is increased, so that a color cast condition caused by impact of the low-voltage sub pixel on the main tone in the side viewing angle is improved, thereby ensuring alleviation of a viewing angle color cast problem, and increasing displayed luminance of a main signal in the side viewing angle. Backlight luminance is improved to three times of an original luminance, and therefore, regarding overall image quality, displayed luminance of the first, second, and third sub pixel combination remains unchanged. According to a combination of zone average signals, it may be determined that, regarding sub pixels in a frame 2, most sub pixels being 0 is mostly a minimum color of the zone average signal; and whether the color is an important feature color is determined according to whether compensation signals for the minimum color in the frame 2 exist in continuous large areas or a quantity of compensation signals for the color in the zone. If the color is not the important feature color, when the frame 2 is displayed in the zone, a light source of the color of first, second, and third colors of a backlight source whose most sub pixel signals are 0 is turned off. In addition, because the frame 2 displays only a combination signal of a color other than the color of the minimum average signal. Therefore, the frame displays only a backlight signal of the color. Similarly, a frame 3 displays only a combination signal of a last color. Different frames provide different color backlight luminance signals, so that energy saving is implemented. There is no need to increase red, green, and blue light source strengths to three time of the original luminance all the time. Therefore, impact on image quality or image display may be the minimum, and energy saving and color cast improvement may be implemented.

### BRIEF DESCRIPTION OF THE DRAWINGS

FIG. 1 is a diagram of a relationship between a color system and a color cast of an exemplary LCD before color cast adjustment;

FIG. 2 is a diagram of a relationship between a red color cast and a grayscale of an LCD before color cast adjustment according to an embodiment of this application;

FIG. 3 is a diagram of a relationship between a green color cast and a grayscale of an LCD before color cast adjustment according to an embodiment of this application;

FIG. 4 is a diagram of a relationship between a blue color cast and a grayscale of an LCD before color cast adjustment according to an embodiment of this application;

FIG. 5 is a diagram of a relationship between red X, green Y, and blue Z of red, green, and blue in a front viewing angle and a grayscale of an LCI) before color cast adjustment according to an embodiment of this application;

FIG. 6 is a diagram of a relationship between red X, green Y, and blue Z of red, green, and blue in a large viewing angle and a grayscale of an LCD before color cast adjustment according to an embodiment of this application;

FIG. 7 is a schematic diagram of an apparatus for driving a display apparatus according to an embodiment of this application; and

FIG. 8 is a flowchart of a method for driving a display apparatus according to an embodiment of this application,

### DETAILED DESCRIPTION

The following embodiments are described with reference to the accompanying drawings, which are used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, units with similar strictures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout the specification, “on” means that one is located above or below a target component and does not necessarily mean that one is located on the top based on a gravity direction.

To further describe the technical measures taken in this application to achieve the intended application objective and effects thereof, specific implementations, structures, features, and effects of a driving method of the display apparatus, and a driving apparatus thereof that are provided according to this application are described below in detail with reference to the drawings and preferred embodiments.

A display apparatus of this application comprises a display panel and a backlight module disposed opposite to each other. The display panel mainly comprises a color filter substrate, an active array substrate, and a liquid crystal layer sandwiched between the two substrates. The color filter substrate, the active array substrate, and the liquid crystal layer may form a plurality of pixel units arranged in an array. The backlight module may emit light rays penetrating through the display panel, and display colors by using each pixel unit of the display panel, to form an image.

In an embodiment, the display panel of this application may be a curved-surface display panel, and the display apparatus of this application may also be a curved-surface display apparatus.

Currently, in terms of an improvement of a wide viewing angle technology of a vertical alignment (VA) display panel, manufacturers of display apparatuses have developed a photo-alignment technology to control an alignment direction of liquid crystal molecules, thereby improving optical performance and a yield rate of a display panel. The photo-alignment technology is to form multi-domain alignment in each pixel unit of a panel, so that liquid crystal molecules in a pixel unit tilt towards, for example, four different directions. The photo-alignment technology is to irradiate a polymer thin film (an alignment layer) of a color filter substrate or a thin film transistor substrate by using an ultraviolet light source (for example, polarized light), so that polymer structures on a surface of the thin film perform non-homogeneous photopolymerization, isomerization, or pyrolysis, inducing chemical bond structures on the surface of the thin film generate special directivities, so as to further induce forward-only arrangement of liquid crystal molecules, thereby performing photo-alignment.

According to different orientation manners of liquid crystals, currently, display panels on a mainstream market may be classified into the following types: a VA type, a TN or super twisted nematic (STN) type, an in-plane switching (IPS) type, and a fringe field switching (FFS) type. Displays of a VA mode include, for example, a patterned vertical alignment (PVA) display or a multi-domain vertical alignment (MVA) display apparatus. The PVA display achieves a wide viewing angle effect by using a fringing field effect and a compensation plate. The MVA display apparatus divides one pixel into a plurality of areas, and makes, by using a protrusion or a particular pattern structure, liquid crystal molecules in different areas tilt towards different directions, to achieve a wide viewing angle and improve a penetration transmittance. In an IPS mode or an FFS mode, by applying an electric field including components approximately parallel to a substrate, liquid crystal molecules make responses in a direction parallel to a plane of the substrate and are driven. An IPS display panel and an ITS display panel have advantages of wide viewing angles.

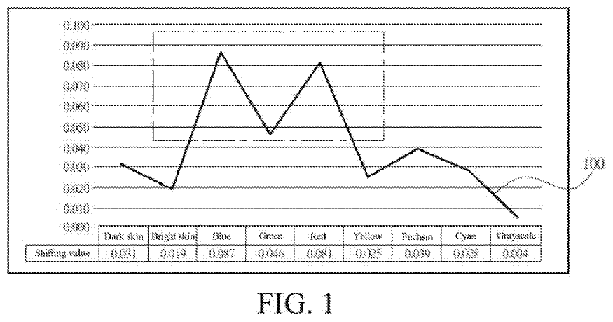

FIG. 1 is a diagram of a relationship between a color system and a color cast of an exemplary LCD before color cast adjustment. Referring to FIG. 1, in an LCD, due to correlation between a refractive index and a wavelength, transmittances of different wavelengths are related to phase delays of different wavelengths, and transmittances have different performances according to different wavelengths. In addition, with drive of a voltage, phase delays of different wavelengths also generate changes of different degrees, affecting performances of transmittances of different wavelengths. FIG. 1 shows changes of color casts between large viewing angles and front viewing angles of various representative color systems of an LCD. It can be obviously found that conditions of color casts 100 of large viewing angles of color systems of red, green, and blue hues are all more severe than those of other color systems. Therefore, overcoming color cast defects of the red, green, and blue hues can greatly improve an overall color cast of a large viewing angle.

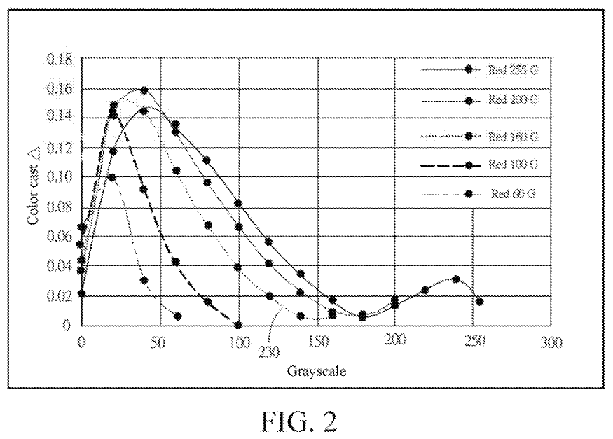

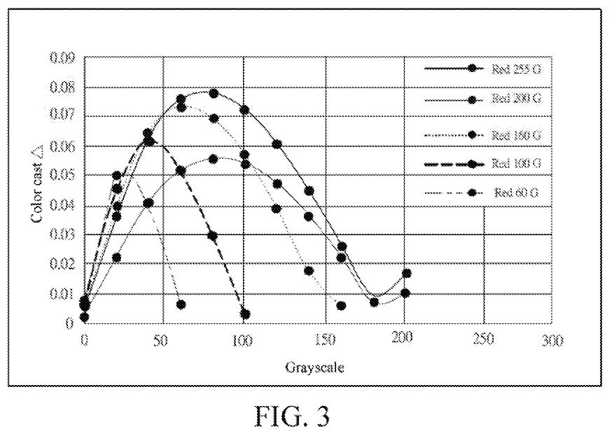

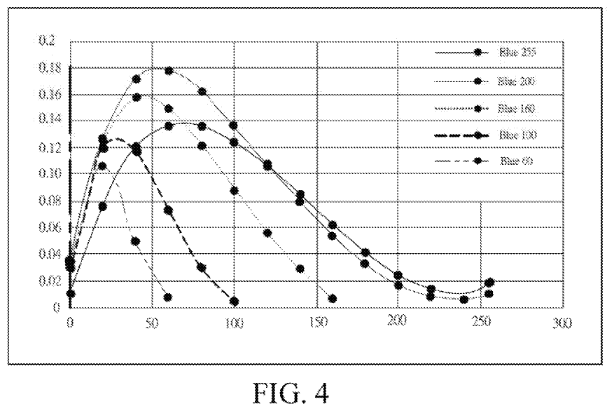

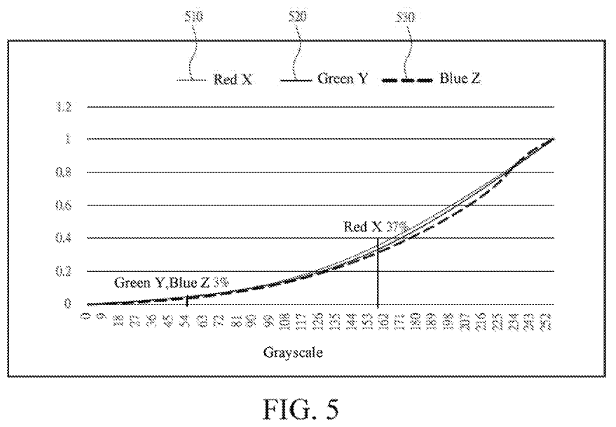

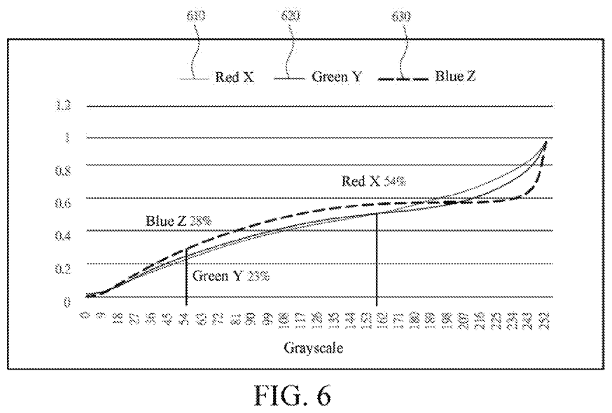

FIG. 2 is a diagram of a relationship between a red color cast and a grayscale of an LCD before color cast adjustment according to an embodiment of this application; FIG. 3 is a diagram of a relationship between a green color cast and a grayscale of an LCD before color cast adjustment according to an embodiment of this application; FIG. 4 is a diagram of a relationship between a blue color cast and a grayscale of an LCD before color cast adjustment according to an embodiment of this application; FIG. 5 is a diagram of a relationship between red X, green Y, and blue Z of red, green, and blue in a front viewing angle and a grayscale of an LCD before color cast adjustment according to an embodiment of this application; and FIG. 6 is a diagram of a relationship between red X, green Y, and blue Z of red, green, and blue in a large viewing angle and a grayscale of an LCD before color cast adjustment according to an embodiment of this application. Referring to FIG. 2, FIG. 3, and FIG. 4, FIG. 2 shows viewing angle color difference change conditions of a front viewing angle and a 60-degree horizontal viewing angle under different color mixing conditions of a green system. A color cast of a red hue combination: When a grayscale of a red curve 230 is 160, green and blue grayscales are in a range of 0 to 255. A mixed red hue color means that when green and blue signals are lower than a red signal, or are quite small compared with a red signal. With increases of the differences between the green and blue, and red signals, a viewing angle color cast condition is gradually severe. Similarly, a color cast change of a green hue combination in FIG. 3: With increases of differences between red and blue, and green signals, a viewing angle color cast condition is gradually severe. A color cast change of a blue hue combination in FIG. 4: With increases of differences between red and green, and blue signals, a viewing angle color cast condition is gradually severe.

For a reason of a color cast, refer to FIG. 5, FIG. 6, and the following descriptions. For example, grayscales of a mixed color in a front viewing angle are red 160, green 50, and blue 50; and grayscale ratios of red X510, green Y520, blue Z530 to full grayscales red 255, green 255, and blue 255 in a corresponding front viewing angle are 37%, 3%, and 3% in color mixing, and grayscale ratios of red X610, green Y620 and blue Z630 to full grayscales red 255, green 255, and blue 255 in a corresponding large viewing angle are 54%, 23%, and 28% in color mixing. Ratios of red X, green Y, and blue Z in the mixed color in the front viewing angle are different from those of red X, green Y and blue Z in a mixed color in the large viewing angle. Consequently, luminance ratios of green Y and blue Z to the red X in the original front viewing angle are considerably small, and luminance ratios of green Y and blue Z to the red X in the large viewing angle are non-neglectable. Therefore, a red hue in the large viewing angle is not as bright as a red hue in the front viewing angle, and has an obvious color cast.

With reference to descriptions in FIG. 2, color cast changes of various red hue combinations: With increases of differences between green and blue, and red signals, a viewing angle color cast condition is gradually severe. A reason of the color cast is described in the foregoing descriptions of FIG. 5 and FIG. 6, and is that red, green, and blue luminance ratios 37%, 3%, and 3% in a front viewing angle considerably differs from red, green, and blue luminance ratios 54%, 23%, and 28% in a large viewing angle. In addition, a lower grayscale signal indicates a larger luminance difference between a front viewing angle and a side viewing angle, because of a rapid saturation improvement of a viewing angle luminance ratio of grayscale liquid crystal display. An international-level national recommended color cast value may be: a color difference≤0.02. The color cast value has a relatively good liquid crystal display angle observation feature. In this application, an original frame signal is changed to a combination of a plurality of frames, reducing luminance differences between red, green, and blue in a front viewing angle and a side viewing angle, to achieve low color cast picture quality display.

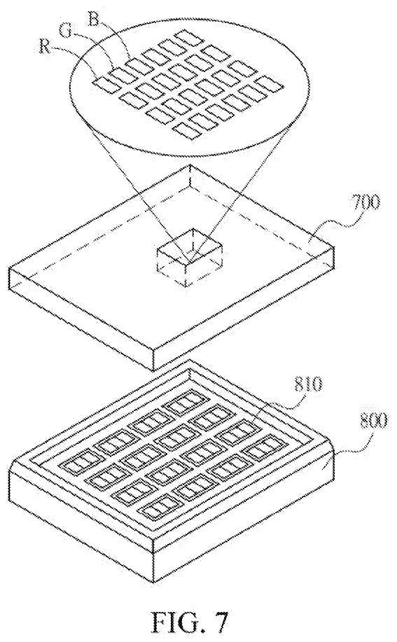

FIG. 7 is a schematic diagram of an apparatus for driving a display apparatus according to an embodiment of this application. Referring to FIG. 7, according to an embodiment of this application, a apparatus 800 for driving a display apparatus comprises a plurality of red, green, and blue sub pixels. Each group of red, green, and blue sub pixels is referred to as a pixel unit 810. Each pixel unit 810 represents an image signal. In this application, red, green, and blue light emitting diode backlight sources are further divided into a plurality of zones. Each zone 700 comprises a plurality of pixel units. The size of the zone may be self-defined. The backlight source and a display may be divided into columns*rows (N*M) zones. Each zone comprises independent red, green, and blue light emitting diode light sources. The apparatus for driving a display apparatus in this application is configured to: calculate average signals of sub pixel units in a zone 700 to obtain a zone red average signal, a zone green average signal, and a zone blue average signal; determine, according to the average signals in the zone, that a minimum average signal is a lowest average signal sub pixel mainly belonging to a hue of which one of red, green, and blue; determine that minimum signals of most pixel units in the zone are hues of one sub pixel of red, green, and blue; perform frame signal combination and allocation; p obtain, according to a zone average value range, a calculation of a minimum average signal in a frame sub pixel signal, determine zone frame times, and correspondingly adjust luminance of red, green, and blue light sources; and adjust backlight luminance.

Referring to FIG. 7, in an embodiment, a driving apparatus 800 of a display apparatus comprises at least one zone 700. Each zone 700 comprises a plurality of pixel units. Each pixel unit 810 comprises a red sub pixel unit, a green sub pixel unit, and a blue sub pixel unit. The driving apparatus 800 is configured to: calculate average signals of sub pixel units in a zone 700 to obtain a zone red average signal, a zone green average signal, and a zone blue average signal; determine, according to the average signals in the zone, that a minimum average signal is a lowest average signal sub pixel mainly belonging to a hue of which one of red, green, and blue; determine that minimum signals of most pixel units in the zone are hues of one sub pixel of red, green, and blue; perform frame signal combination and allocation; obtain, according to a zone average value range, a calculation of a minimum average signal in a frame sub pixel signal, determine zone frame times, and correspondingly adjust luminance of red, green, and blue light sources; and adjust backlight luminance, wherein the zone average value range is a first condition range, and the calculation of the minimum average signal in the frame sub pixel signal is a second condition range, so that the zone frame times is determined, and the luminance of the red, green, and blue light sources is correspondingly adjusted; and the red sub pixel unit, the green sub pixel unit, and the blue sub pixel unit are arranged in arrays.

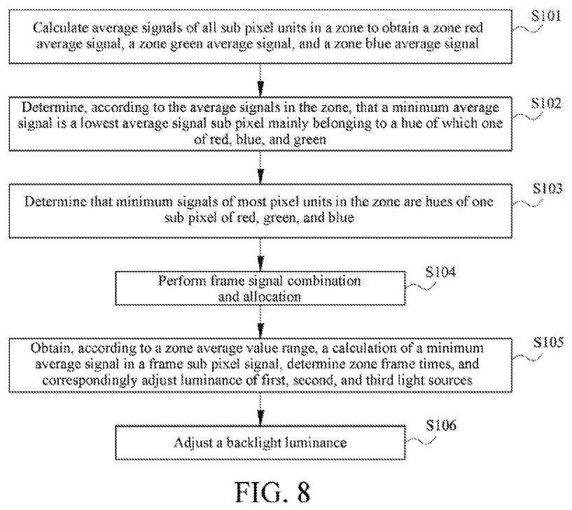

FIG. 8 is a flowchart of a method for driving a display apparatus according to an embodiment of this application. Referring to FIG. 8, in an embodiment of this application, a method for driving a display apparatus comprises: calculating average signals of sub pixel units in a zone 700 to obtain a zone red average signal, a zone green average signal, and a zone blue average signal; determining, according to the average signals in the zone, that a minimum average signal is a lowest average signal sub pixel mainly belonging to a hue of which one of red, green, and blue; determining that minimum signals of most pixel units in the zone are hues of one sub pixel of red, green, and blue; performing frame signal combination and allocation; obtaining, according to a zone average value range, a calculation of a minimum average signal in a frame sub pixel signal, determining zone frame times, and correspondingly adjusting luminance of red, green, and blue light sources; and adjusting backlight luminance.

In an embodiment, a red hue combination when the average signals of all pixel units in the zone is the red average signal, the green average signal, and the blue average signal, where the red average signal>the green average signal>the blue average signal, if in the zone, there is a red hue combination whose pixel units are a red pixel unit, a green pixel unit, and a blue pixel unit, and if an order of grayscale signals when the red pixel unit>the green pixel unit>the blue pixel unit is the same as an order of grayscale signals when the average signals in the zone is the red average signal, the green average signal, and the blue average signal, where the red average signal>the green average signal>the blue average signal, that a minimum common signal of the red pixel unit, the green pixel unit, and the blue pixel unit of the sub pixel unit is the blue pixel unit is obtained.

In an embodiment, the grayscale signals of the red pixel unit, the green pixel unit, and the blue pixel unit of the sub pixel unit are changed from one frame to signal combinations of three frames, and a frame 1 is a combination of a first red pixel unit, a first green pixel unit, and a first blue pixel unit; a frame 2 is a combination of a second red pixel unit, a second green pixel unit, and a second blue pixel unit; and a frame 3 is a combination of a third red pixel unit, a third green pixel unit, and a third blue pixel unit. The signal combinations of the frame 1, the frame 2, and the frame 3 satisfy: the first red pixel unit+the second red pixel unit+the third red pixel unit=the red pixel unit, the first green pixel unit+the second green pixel unit+the third green pixel unit=the green pixel unit, and the first blue pixel unit+the second blue pixel unit+the third blue pixel unit=the blue pixel unit.

In an embodiment, in the combination 1 of the first red pixel unit, the first green pixel unit, and the first blue pixel unit of a sub pixel signal of the frame 1, a minimum color blue pixel unit and a pixel signal blue pixel unit of the sub pixel unit are used as a common sub pixel signal of the frame, that is, the first red pixel unit=the blue pixel unit, the first green pixel unit=the blue pixel unit, and the first blue pixel unit=the blue pixel unit.

In an embodiment, the second red pixel unit, the second green pixel unit, and the second blue pixel unit of a sub pixel signal of the frame 2 is one sub pixel color of a common sub pixel signal of differences between the red pixel unit, the green pixel unit, and the blue pixel unit of an original signal and those of the signal of the frame 1, that is, red, green, and blue sub pixel difference signals are respectively the red pixel unit=the blue pixel unit, the green pixel unit—the blue pixel unit, and 0. When a red sub pixel signal of the difference signal is used in the frame 2, a sub pixel signal combination of the frame 2 is: the second red pixel unit=the red pixel unit—the blue pixel unit, the second blue pixel unit=0, and the second blue pixel unit=0.

In an embodiment, the frame 3 is another green sub pixel signal of the difference, and a sub pixel signal combination of the frame 3 is: the third red pixel unit=0,the third green pixel unit=the green pixel unit-the blue pixel unit, and the third blue pixel unit=0.

In an embodiment, the zone average value range is a first condition range, and the calculation of the minimum average signal in the frame sub pixel signal is a second condition range, so that the zone frame times is determined, and the luminance of the red, the green, and the blue light sources is correspondingly adjusted.

In an embodiment, the first condition range and the second condition range are selected from the following determining cases: a first case: when a first condition range is the red average signal>the green average signal>the blue average signal, the blue average signal is the minimum average color signal, regarding compensation signals in a frame 2 in the zone, whether compensation signals exists in continuous sub pixels is determined, a signal B′2 i,j that needs to be theoretically compensated for the color in the frame 2 in the zone is calculated, and statistics on all compensation signals B′2 i,j in the zone are collected; and when a second condition range satisfies a condition that if in a sub pixel signal B′2n,m_i,j in the frame 2 in the zone (n, m), continuous sub pixels of a matrix k*k satisfies a condition: B′2n,m_i,j percentage of a first high saturation exceeding X%, where k is a customizable feature zone block sub pixel matrix range, CTH1 is customizable and indicates that satisfied compensation signals exceeds a threshold, X1 is a customizable ratio of a quantity of sub pixels, in k*k continuous sub pixels, exceeding the CTH1 compensation signals, a blue light source signal in the frame 2 is not adjusted to 0 and strengths of third light sources that are backlight sources both in a frame 1 and the frame 2 are still kept to 3 times of an original backlight, where when the average signals in the zone are in other order combinations, for example, if A>B>C, C>B>A, C>A>B, B>A>C, B>C>A, regarding minimum average sub pixel colors in the zone: red, green, and blue, whether luminance of red, green, and blue signals of the backlight source in the frame 2 is adjusted to 0; a second case: when a first condition range is the red average signal=A>the green average signal=B>the blue average signal=C, the blue average signal is the minimum average color signal, regarding compensation signals in a frame 2 in the zone, whether compensation signals exists in continuous sub pixels is determined, a signal B′2 i,j that needs to be theoretically compensated for the color in the frame 2 in the zone is calculated, and statistics on all compensation signals B′2 i,j in the zone are collected; and when a second condition range satisfies a condition that if sub pixel signals B′2n,m_ i,j in the frame 2 in the zone (n, m) satisfies a condition: B′2_n,m_i,j≥a sub pixel percentage of CTH2 that occupies a quantity of all the sub pixels B′2n,m in the zone, exceeding Y%, where CTH2 is customizable and indicates that satisfied compensation signals exceeds a threshold, Y1 is a customizable ratio of a quantity of sub pixels, in all the sub pixels B′2n,m in the zone, exceeding the CTH2 compensation signals, a blue light source signal in the frame 2 is not adjusted to 0 and strengths of third light sources that are backlight sources both in a frame 1 and the frame 2 are still kept to 3 times of an original backlight, where when the average signals in the zone are in other order combinations, for example, if A>C>B, C>B>A, C>A>B, B>A>C, B>C>A, regarding minimum average sub pixel colors in the zone: red, green, and blue, whether luminance of red, green, and blue signals of the backlight source in the frame 2 is adjusted to 0; and a third case: when a first condition range is a red hue combination when the red average signal=A, the green average signal=B, and the blue average signal=C, most sub pixel combinations are grayscale signals A>B>C; and when a second condition range does not satisfy calculation and determining formulas in the first case and the second case, a blue light source signal in a frame 2 is adjusted to 0, a green light source signal in the frame 2 is adjusted to 0, and red and blue light source signals in a frame 3 are adjusted to 0.

Referring to FIG. 8, step S101 is: Calculate average signals of sub pixel units in a zone to obtain a zone red average signal, a zone green average signal, and a zone blue average signal.

Referring to FIG. 8, step S102 is: Determine, according to the average signals in the zone, that a minimum average signal is a lowest average signal sub pixel mainly belonging to a hue of which one of red, blue, and green.

Referring to FIG. 8, step S103 is: Determine that minimum signals of most pixel units in the zone are hues of one sub pixel of red, green, and blue.

Referring to FIG. 8, step S104 is: Perform frame signal combination and allocation.

Referring to FIG. 8, step S105 is: Obtain, according to a zone average value range, a calculation of a minimum average signal in a frame sub pixel signal, determine zone frame times, and correspondingly adjust luminance of first, second, and third light sources.

Referring to FIG. 8, step S106 is: Adjust a backlight luminance.

In an embodiment, sub pixel units Ri,j, Gi,j, and Bi,j (where i,j indicates a group of R, G, and B pixel units in the display area) in a display area is calculated, for example, a red hue combination when Ri,j=100, Gi,j=80, and Bi,j=40. A minimum common signal of Ri,j, Gi,j, and Bi,j is 40 grayscales, so that an grayscale signal of Ri,j, Gi,j, and Bi,j is changed to three combinations, and the three combinations are respectively a combination 1 of R1i,j, G1i,j and B1i,j, a combination 2 of R2i,j, G2i,j, and B2i,j, and a combination 3 of R3i,j, G3i,j, and B3i,j. The combination 1 of R1i,j, G1i,j, and B1i,j is a minimum common signal: 40 grayscales, that is, R1i,j=40, G1i,j=40, and B1i,j=40. The combination 2 of R2i,j, G2i,j, and B2i,j is one color of a difference between an original signal and the combination I signal. As described above, the combination 2 may be R2 i,j=60, G2 i,j=0, and B2 i,j=0 or R2 i,j=0, G2 i,j=40, and B2 i,j=0. The combination 3 is a remaining last signal color, that is, R3 i,j=0, G3 i,j=40, and B3 i,j=0 or R3 i,j=60, G3 i,j=0 and B3 i,j=0. Except that the combination 1 is the minimum signal, a color order of the combinations 2 and 3 may be that any color of the remaining signal is preferentially displayed.

In an embodiment, the original sub pixel signal R i,j, G i,j, and B i,j is changed to three frame signal combinations, and the three frame signal combinations are displayed in a chronological order. An original frame signal needs to be tripled. At one time, the combination 1 of R1 i,j, G1 i,j, and B1 i,j is displayed; at another time, the combination 2 of R2 i,j, G2 i,j, and B2 i,j is displayed; and at still another time, the combination 3 of R3 i,j, G3 i,j, and B3 i,j is displayed.

Referring to FIG. 5 and FIG. 6, in an embodiment, assuming that a front viewing angle luminance ratio of an original frame signal Ri,j=100, Gi,j=80, and Bi,j=40 to a full grayscale signal Gray 255 is SR%, LG%, and MB%, a side viewing angle luminance is correspondingly SR%, LG%, and MB%, where SR>LG>MB, and SR′>LG′>MB′. However, as described above, a larger difference between a front viewing angle luminance and a side viewing angle luminance for a lower grayscale signal indicates SR/MB>SR′/MB′ and LG/MB>LG′/MB′. Therefore, by means of color mixing, a luminance difference between a main luminance signal SR and an MB signal in a front viewing angle is large, but a luminance difference between a main luminance signal SR′ and an MB′ signal in a front viewing angle is small. Consequently, a viewing angle main tone color is affected and color brightness is decreased. Referring to FIG. 5, SR%=13.3%, LG%=8% and MB=1.8%. Referring to FIG. 6, SR′%=40%, LG′%=33%, and MB′=17%.

Referring to FIG. 5 and FIG. 6, in an embodiment, a frame combination is used, in the combination 1, because signals of R1 i,j, G1 i,j, and B1 i,j are all 40 grayscales. Therefore, it may be assumed that in FIG. 5, a front viewing angle luminance ratio of R1 i,j, G1 i,j, and B1 i,j in the frame is 1.8%, 1.8%, and 1.8%. In FIG. 6, a side viewing angle luminance is correspondingly 17%, 17%, and 17%. In FIG. 5, a front viewing angle luminance ratio of the combination 2 of R2 i,j=60, G2 i,j=0, B2 i,j=0 in the frame is 3.8%, 0%, and 0%. In FIG. 6, a side viewing angle luminance is correspondingly 26.8%, 0%, and 0%. In FIG. 5, a front viewing angle luminance ratio of the combination 3 of R2 i,j=0, G2 i,j=40, and B2 i,j=0 in the frame is 0%, 1.8%, and 0%. In FIG. 6, a side viewing angle luminance is correspondingly 0%, 17%, and 0%. A color mixing ratio of the frame 1, the frame 2, and the frame 3 in a side viewing angle, that is, Ri,j:Gi,j:Bi,j, is 17%+26.8%+0%=43.8%, 17%+0%+17%=34%, and 7%+0%+0%=17%. A side viewing angle luminance ratio of the original frame, that is, is 38%, 30%, and 17%. Obviously, a luminance ratio of a main tone R to B is improved from original frame 40/17=2.35 to combination frames 43.8/17=2.57. A pixel of the main tome is obviously improved compared with another tone. Therefore, the main tone is displayed in a viewing angle close to a front viewing angle.

In an embodiment, when in the zone, there is another sub pixel unit combination: R′i,j, G′i,j, and B′i,j (where i,j is a group of R, G, and B pixel units in the display zone), for example, a green hue combination when R′i,j=A2, G′i,j=B2, and B′i,j=C2. It is assumed that an order of grayscale signals corresponding to B2>C2>A2 is different from an order of grayscale signals corresponding to a red hue combination when the average signals in the zone is a red average signal-A, a green average signal-B, and a blue average signal=C, where A>B>C.

In an embodiment, for example, a minimum common signal of R′i,j, G′i,j, and B′i,j is A2. Therefore, an grayscale signal of the sub pixel unit R′i,j, G′i,j, and B′i,j is changed to three grayscale frames, respectively a frame combination 1 of R′i,j, G′i,j, and B′1i,j, a frame combination 2 of R′2i,j, G′2i,j, and B′2i,j, and a frame combination 3 of R′1i,j, G′3i,j, and B′3i,j. Frame 1, frame 2, and frame 3 signal combinations satisfy: R′1i,j+R′2 i,j+R′3 i,j, G′1i,j+G′2 i,j+G′3i,j=G′i,j, and B′1i,j+B′2 i,j+B′3 i,j=B′i,j. In the combination 1 of R′1i,j, G′1i,j, and B′1i,j, a minimum color R′i,j and a pixel signal A2 of the sub pixel unit are used as a common sub pixel signal of the frame, that is, R′1i,j=A2, G′1i,j=A2, and B′1i,j=A2. The sub pixel signal R2 i,j, G2 i,j, and B2 i,j of the frame 2 is one sub pixel color of a common sub pixel signal of differences between Ri,j, Gi,j, and Bi,j of an original signal and those of the signal of the frame 1, that is, R, G, and B sub pixel difference signals are respectively 0, B2−A2, and C2−A2. A sub pixel signal of the difference signal is used in the frame 2, and another sub pixel signal of the difference signal is used in the frame 3. When a red sub pixel signal of the difference signal is used in the frame 2, a sub pixel signal combination of the frame 2 is: R2 i,j=0, G2 i,j=0, and B2 i,j=C2−A2. The frame 3 is another green sub pixel signal of the difference, and a sub pixel signal combination of the frame 3 is: R3 i,j=0, G2 i,j=B2−A2, and B2 i,j=0.

In an embodiment, if there is a red hue combination when the pixel average signals in the zone are a red average signal=A, a green average signal=B, and a blue average signal=C is described, most sub pixel combinations in the zone are grayscale signals satisfying R′i,j>G′i,j>B′i,j. regarding most sub pixel combinations in the zone, a signal R1i,j=A1, G1i,j=B1, and B1i,j=C1 of the frame 1 is a minimum common signal C1.

Therefore, regarding sub pixels in the frame 2 combination, most B2 i,j signals are 0, and a sub pixel color of a common sub pixel signal of differences between Ri,j, Gi,j, and Bi,j of an original signal and those of the signal of the frame 1. If a red pixel unit of the difference signal is displayed in the frame 2, a green sub pixel signal of the frame 2 is separately displayed in the frame 3. Therefore, when the frame 2 is displayed in the zone, green and blue light emitting diode light sources of a backlight source are turned off. Therefore, if a sub pixel in the zone does not satisfy the described above green hue combination R′i,j=A2, G′i,j=B2, and B′i,j=C2 (B2>C2>A2) when signals R′i,j>G′i,j>B′i,j, a signal B′2 i,j=C2−A2 of the frame combination 2 cannot be normally displayed by using the blue light emitting diode light source. However, it may be predicted that due to the red hue combination when the pixel average signals in the zone are the red average signal=A, the green average signal=B, and the blue average signal=C, most sub pixel combinations are grayscale signals A>B>C. There are relatively few other combinations in the zone. Therefore, few compensation signals B′i,j are not represented in the frame 2 signal of the sub pixel. Therefore, an overall color or image quality is not greatly affected. Regarding the sub pixel signal in the frame combination 3, only a green signal is displayed, and G2 i,j and B2 i,j signals are 0. Therefore, when the frame 3 is displayed the zone, red and blue light emitting diode light sources of the backlight source are turned off.

In an embodiment, if there is a red hue combination when the average signals in the zone are a red average signal-A, a green average signal-B, and a blue average signal=C, where A>B>C, whether a minimum average signal blue backlight luminance signal in the frame 2 frame is adjusted 0. Similarly, when the average signals in the zone are in other order combinations, for example, A>C>B, C>B>A, C >A >B, B>A>C, B>C>A, regarding minimum average sub pixel colors in the zone: red, green, and blue, whether luminance of red, green, and blue signals of the backlight source in the frame 2 are adjusted to 0.

In this application, by means determining on signals of a red, green, and blue sub pixel combination, each group of red, green, and blue sub pixel input signals are divided into three frame signals for display, and a driving frequency of a display needs to be tripled to separately display the three divided frame signals. By means of the three divided frame signals, main tone luminance in a side viewing angle is improved, a ratio of the main tone luminance of a main sub pixel in the side viewing angle to luminance of an original frame low-voltage sub pixel of in the side viewing angle is increased, so that a color cast condition caused by impact of the low-voltage sub pixel on the main tone in the side viewing angle is improved, thereby ensuring alleviation of a viewing angle color cast problem, and increasing displayed luminance of a main signal in the side viewing angle. Backlight luminance is improved to three times of original luminance, and therefore, regarding overall image quality, displayed luminance of the red, green, and blue sub pixel combination remains unchanged. According to a combination of zone average signals, it may be determined that, regarding sub pixels in a frame 2, most sub pixels being 0 is mostly a minimum color of the zone average signal; and whether the color is an important feature color is determined according to whether compensation signals for the minimum color in the frame 2 exist in continuous large areas or a quantity of compensation signals for the color in the zone, If the color is not the important feature color, when the frame 2 is displayed in the zone, a light source of the color of red, green, and blue colors of a backlight source whose most sub pixel signals are 0 is turned off. In addition, because the frame 2 displays only a combination signal of a color other than the color of the minimum average signal. Therefore, the frame displays only a backlight signal of the color. Similarly, a frame 3 displays only a combination signal of a last color. Different frames provide different color backlight luminance signals, so that energy saving is implemented. There is no need to increase red, green, and blue light source strengths to three time of the original luminance all the time. Therefore, impact on image quality or image display may be the minimum, and energy saving and color cast improvement may be implemented.

The wordings such as “in some embodiments” and “in various embodiments” are repeatedly used. The wordings usually refer to different embodiments, but they may also refer to a same embodiment. The words, such as “comprise”, “have”, and “include”, are synonyms, unless other meanings are indicated in the context thereof.

The foregoing descriptions are merely preferred embodiments of this application, and are not intended to limit this application in any form. Although this application has been disclosed above through the preferred embodiments, the embodiments are not intended to limit this application, Any person skilled in the art can make some variations or modifications, which are equivalent changes, according to the foregoing disclosed technical content to obtain equivalent embodiments without departing from the scope of the technical solutions of this application. Any simple amendment, equivalent change, or modification made to the foregoing embodiments according to the technical essence of this application without departing from the content of the technical solutions of this application shall fall within the scope of the technical solutions of this application.

What is claimed is:

1. A method for driving a display apparatus, comprising:
calculating average signals of sub pixel units in a zone to obtain a zone first average signal, a zone second average signal, and a zone third average signal;
determining, according to the average signals in the zone, a smallest average signal as a lowest average signal sub pixel in terms of a dominant hue out of first, second, and third hues;
determining that minimum signals of most pixel units in the zone are hues of one sub pixel of the first, the second, and the third;
performing frame signal combination and allocation;
obtaining, according to a zone average value range, a calculation of a minimum average signal in a frame sub pixel signal, determining zone frame times, and correspondingly adjusting luminance of first, second, third light sources; and
adjusting a backlight luminance.

2. The method for driving a display apparatus according to claim 1, a first hue combination when the average signals of all pixel units in the zone is the first, the second, and the third.

3. The method for driving a display apparatus according to claim 2, wherein the first average signal>the second average signal>the third average signal.

4. The method for driving a display apparatus according to claim 3, wherein if in the zone, there is a first hue combination when a group of pixel units is a first pixel unit, a second pixel unit, and a third pixel unit; and if an order of grayscale signals when the first pixel unit>the second pixel unit>the third pixel unit is the same as an order of grayscale signals when the average signals in the zone is the first, the second, and the third, where the first average signal>the second average signal>the third average signal, that a minimum common signal of the first pixel unit, the second pixel unit, and the third pixel unit of the sub pixel unit is the third pixel unit is obtained.

5. The method for driving a display apparatus according to claim 2, wherein the grayscale signals of the first pixel unit, the second pixel unit, and the third pixel unit of the sub pixel unit are changed from one frame to signal combinations of three frames; a frame 1 is a combination of a first first pixel unit, a first second pixel unit, and a first third pixel unit; a frame 2 is a combination of a second first pixel unit, a second second pixel unit, and a second third pixel unit; and a frame 3 is a combination of a third first pixel unit, a third second pixel unit, and a third third pixel unit.

6. The method for driving a display apparatus according to claim 5, wherein the signal combinations of the frame 1, the frame 2, and the frame 3 satisfy: the first first pixel unit+the second first pixel unit+the third first pixel unit=the first pixel unit, the first second pixel unit+the second second pixel unit+the third second pixel unit=the second pixel unit, and the first third pixel unit+the second third pixel unit+the third third pixel unit=the third pixel unit.

7. The method for driving a display apparatus according to claim 6, wherein in the combination 1 of the first first pixel unit, the first second pixel unit, and the first third pixel unit of a sub pixel signal of the frame 1, a minimum color third pixel unit and a pixel signal third pixel unit of the sub pixel unit are used as a common sub pixel signal of the frame, that is, the first first pixel unit=the third pixel unit, the first second pixel unit the third pixel unit, and the first third pixel unit=the third pixel unit.

8. The method for driving a display apparatus according to claim 6, wherein the second first pixel unit, the second second pixel unit, and the second third pixel unit of a sub pixel signal of the frame 2 is one sub pixel color of a common sub pixel signal of a difference between an original signal: the first pixel unit, the second pixel unit, and the third pixel unit, and the signal of the frame 1, that is, first, second, and third sub pixel difference signals are respectively the first pixel unit-the third pixel unit, the second pixel unit—the third pixel unit, and 0, wherein when a first sub pixel signal of the difference signal is used in the frame 2, a sub pixel signal combination of the frame 2 is: the second first pixel unit=the first pixel unit-the third pixel unit, the second second pixel unit=0, and the second third pixel unit=0.

9. The method for driving a display apparatus according to claim 6, wherein the frame 3 is another second sub pixel signal of the difference, and a sub pixel signal combination of the frame 3 is: the third first pixel unit=0, the third second pixel unit=the second pixel unit-the third pixel unit, and the third third pixel unit=0.

10. The method for driving a display apparatus according to claim 1, wherein the zone average value range is a first condition range, and the calculation of the minimum average signal in the frame sub pixel signal is a second condition range, so that the zone frame times is determined, and the luminance of the first, second, and third light sources is correspondingly adjusted.

11. The method for driving a display apparatus according to claim 10, wherein the first condition range and the second condition range are selected from the following determining cases:
a first case: when a first condition range is the first average signal>the second average signal>the third average signal, the third average signal is the minimum average color signal, regarding compensation signals in a frame 2 in the zone, whether compensation signals exists in continuous sub pixels is determined, a signal that needs to be theoretically compensated for the color in the frame 2 in the zone is calculated, and statistics on all compensation signals in the zone are collected; and when a second condition range satisfies a condition: if in a sub pixel signal in the frame 2 in the zone, continuous sub pixels of a matrix array value satisfies a condition that the sub pixel signal in the frame 2≥a percentage of a first high saturation exceeding a percentage of a value, wherein the matrix array is a customizable feature zone block sub pixel matrix range, the first high saturation is customizable and indicates that satisfied compensation signals exceeds a threshold, the value is a customizable ratio of a quantity of sub pixels, in continuous sub pixels of the matrix array value, sub exceeding the first high saturation compensation signals, a third light source signal in the frame 2 is not adjusted to 0 and strengths of third light sources that are backlight sources both in a frame 1 and the frame 2 are still kept to 3 times of an original backlight, wherein when the average signals in the zone are in other order combinations, for example, if the first average signal>the third average signal>the second average signal, the third average signal>the second average signal>the first average signal, the third average signal>the first average signal>the second average signal, the second average signal>the first average signal>the third average signal, the second average signal>the third average signal>the first average signal, regarding minimum average sub pixel colors in the zone: first, second, and third, whether luminance of first, second, and third signals of the backlight source in the frame 2 is adjusted to 0;
a second case: when a first condition range is the first average signal=the first average signal>the second average signal=the second average signal>the third average signal=the third average signal, the third average signal is the minimum average color signal, regarding compensation signals in a frame 2 in the zone, whether compensation signals exists in continuous sub pixels is determined, a signal that needs to be theoretically compensated for the color in the frame 2 in the zone is calculated, and statistics on all compensation signals in the zone are collected; and when a second condition range satisfies a condition that if sub pixel signals in the frame 2 in the zone satisfies a condition: the sub pixel signals in the frame 2≥a sub pixel percentage of a second high saturation that occupies a quantity of all the sub pixels in the frame 2 in the zone, exceeding a percentage of another value, wherein the second high saturation is customizable and indicates that satisfied compensation signals exceeds a threshold, the another value is a customizable ratio of a quantity of sub pixels, in all the sub pixel signals in the frame 2 in the zone, exceeding the second high saturation compensation signals, a third light source signal in the frame 2 is not adjusted to 0 and strengths of third light sources that are backlight sources both in a frame 1 and the frame 2 are still kept to 3 times of an original backlight, wherein when the average signals in the zone are in other order combinations, for example, if the first average signal>the third average signal>the second average signal, the third average signal>the second average signal>the first average signal, the third average signal>the first average signal>the second average signal, the second average signal>the first average signal>the third average signal, the second average signal>the third average signal>the first average signal, regarding minimum average sub pixel colors in the zone: first, second, and third, whether luminance of first, second, and third signals of the backlight source in the frame 2 is adjusted to 0; and
a third case: when a first condition range is a first hue combination: the first average signal=the first average signal, the second average signal=the second average signal, and the third average signal=the third average signal, most sub pixel combinations are grayscale signals the first average signal>the second average signal>the third average signal; and when a second condition range does not satisfy calculation and determining formulas in the first case and the second case, a third light source signal in a frame 2 is adjusted to 0, a second light source signal in the frame 2 is adjusted to 0, and first and third light source signals in a frame 3 are adjusted to 0.

12. An apparatus for driving a display apparatus, comprising at least one zone, wherein each zone comprises a plurality of pixel units, and each pixel unit comprises a first sub pixel unit, a second sub pixel unit, and a third sub pixel unit; and the apparatus is configured to:
calculate average signals of sub pixel units in a zone to obtain a zone first average signal, a zone second average signal, and a zone third average signal;
determine, according to the average signals in the zone, a smallest average signal as a lowest average signal sub pixel in terms of a dominant hue out of first, second, and third hues;
determine that minimum signals of most pixel units in the zone are hues of one sub pixel of the first, the second, and the third;
perform frame signal combination and allocation;
obtain, according to a zone average value range, a calculation of a minimum average signal in a frame sub pixel signal, determine zone frame times, and correspondingly adjust luminance of first, second, and third light sources; and
adjust a backlight luminance.

13. The apparatus for driving a display apparatus according to claim 12, wherein the zone average value range is a first condition range, and the calculation of the minimum average signal in the frame sub pixel signal is a second condition range, so that the zone frame times is determined and the luminance of the first, second, and third light sources is correspondingly adjusted.

14. The apparatus for driving a display apparatus according to claim 12, wherein the first sub pixel unit, the second sub pixel unit, and the third sub pixel unit are arranged in arrays.

15. The apparatus for driving a display apparatus according to claim 12, wherein a first hue combination when average signals of all pixel units in the zone is the first average signal, the second average signal, and the third average signal.

16. The apparatus for driving a display apparatus according to claim 15, wherein the first average signal>the second average signal>the third average signal.

17. The apparatus for driving a display apparatus according to claim 16, wherein if in the zone, there is a first hue combination when a group of pixel units is a first pixel unit, a second pixel unit, and a third pixel unit; and if an order of grayscale signals when the first pixel unit>the second pixel unit>the third pixel unit is the same as an order of grayscale signals when the average signals in the zone is the first average signal, the second average signal, and the third average signal, where the first average signal>the second average signal>the third average signal, that a minimum common signal of the first pixel unit, the second pixel unit, and the third pixel unit of the sub pixel unit is the third pixel unit is obtained.

18. The apparatus for driving a display apparatus according to claim 15, wherein the grayscale signals of the first pixel unit, the second pixel unit, and the third pixel unit of the sub pixel unit are changed from one frame to signal combinations of three frames; a frame 1 is a combination of a first first pixel unit, a first second pixel unit, and a first third pixel unit; a frame 2 is a combination of a second first pixel unit, a second second pixel unit, and a second third pixel unit; and a frame 3 is a combination of a third first pixel unit, a third second pixel unit, and a third third pixel unit.

19. The apparatus for driving a display apparatus according to claim 18, wherein the signal combinations of the frame 1, the frame 2, and the frame 3 satisfy: the first first pixel unit+the second first pixel unit+the third first pixel unit=the first pixel unit, the first second pixel unit+the second second pixel unit+the third second pixel unit=the second pixel unit, and the first third pixel unit+the second third pixel unit+the third third pixel unit=the third pixel unit.

20. An apparatus for driving a display apparatus, comprising at least one zone, wherein each zone comprises a plurality of pixel units, and each pixel unit comprises a first sub pixel unit, a second sub pixel unit, and a third sub pixel unit; and the apparatus is configured to:
calculate average signals of sub pixel units in a zone to obtain a zone first average signal, a zone second average signal, and a zone third average signal;
determine, according to the average signals in the zone, a smallest average signal as a lowest average signal sub pixel in terms of a dominant hue out of first, second, and third hues;
determine that minimum signals of most pixel units in the zone are hues of one sub pixel of the first, the second, and the third;
perform frame signal combination and allocation;
obtain, according to a zone average value range, a calculation of a minimum average signal in a frame sub pixel signal, determine zone frame times, and correspondingly adjust luminance of first, second, and third light sources; and
adjust a backlight luminance, wherein the zone average value range is a first condition range, and the calculation of the minimum average signal in the frame sub pixel signal is a second condition range, so that the zone frame times is determined and the luminance of the first, second, and third light sources is correspondingly adjusted; and the first sub pixel unit, the second sub pixel unit, and the third sub pixel unit are arranged in arrays.
